(19) United States
(12) Patent Application Publication
(10) Pub. No.: US 2025/0096625 A1
(43) Pub. Date: Mar. 20, 2025

(54) STATOR

(71) Applicant: Schaeffler Technologies AG & Co. KG, Herzogenaurach (DE)

(72) Inventors: Vikrant Tailor, Essen (DE); Tim Ferebauer, Düren (DE); Alexandre Fischer, Strasbourg (FR); Christian Kühhirt, Steinbach-Hallenberg (DE)

(73) Assignee: Schaeffler Technologies AG & Co. KG, Herzogenaurach (DE)

(21) Appl. No.: 18/729,516

(22) PCT Filed: Dec. 15, 2022
(86) PCT No.: PCT/DE2022/100958

§ 371 Date: Jul. 17, 2024

(30) Foreign Application Priority Data
Jan. 27, 2022 (DE) 10 2022 101 923.3

(51) Int. Cl. H02K 1/20; H02K 5/15; H02K 9/19

(52) U.S. Cl. CPC H02K 1/20; H02K 5/15; H02K 9/19

(57) ABSTRACT

A stator for an electric machine includes a stator body that is made of a plurality of stator sheets arranged in layers and has a plurality of fluid channels through which a cooling fluid can flow and including an A-bearing shield and a B-bearing shield, each of which is arranged on a respective stator body end face, the end faces lying opposite each other. The A-bearing shield and/or the B-bearing shield and/or the stator body has/have at least one hydraulic connection, by means of which the cooling fluid can be conducted through the A-bearing shield and/or the B-bearing shield and/or the stator body to at least one of the fluid channels. The stator body has a first group of stator sheets including a plurality of fluid channels which extend through the stator body substantially in the axial direction, and a second group of stator sheets including a plurality of connection channels which extend through the stator body substantially in the circumferential direction and by means of which two fluid channels that are adjacent to each other in the circumferential direction are fluidically coupled together.

### CROSS-REFERENCE TO RELATED APPLICATIONS

This application is the U.S. National Phase of PCT Appln. No. PCT/DE2022/100958 filed Dec. 15, 2022, which claims priority to DE 10 2022 101 923.3 filed Jan. 27, 2022, the entire disclosures of which are incorporated by reference herein.

### TECHNICAL FIELD

The present disclosure relates to a stator for an electric machine, comprising a stator body which is formed from a plurality of stator laminations arranged in layers, and wherein the stator body has a plurality of fluid channels through which a cooling fluid can flow, as well as a A-bearing shield and an B-bearing shield, which are arranged in each case on the end face and on opposite end faces of the stator body, wherein the A-bearing shield and/or the B-bearing shield has/have at least one hydraulic connection, by means of which the cooling fluid can be conducted through the A-bearing shield and/or the B-bearing shield to at least one of the fluid channels.

### BACKGROUND

Electric motors are increasingly being used to drive motor vehicles in order to create alternatives to internal combustion engines that require fossil fuels. Significant efforts have already been made to improve the suitability of electric drives for everyday use and also to be able to offer users the driving comfort they are accustomed to.

A detailed description of an electric drive can be found in an article in the German automotive magazine ATZ, volume 113, 05/2011, pages 10-14 by Erik Schneider, Frank Fickl, Bernd Cebulski and Jens Liebold with the title: Hochintegrativ und Flexibel Elektrische Antriebseinheit für E-Fahrzeuge [Highly Integrative and Flexible Electric Drive Unit for E-Vehicles]. This article describes a drive unit for an axle of a vehicle, which comprises an electric motor that is arranged to be concentric and coaxial with a bevel gear differential, wherein a shiftable 2-speed planetary gear set is arranged in the power train between the electric motor and the bevel gear differential and is also positioned to be coaxial with the electric motor or the bevel gear differential or spur gear differential. The drive unit is very compact and allows for a good compromise between climbing ability, acceleration and energy consumption due to the shiftable 2-speed planetary gear set. Such drive units are also referred to as e-axles or electrically operable drive trains.

In addition to purely electrically operated drive trains, hybrid drive trains are also known. Such drive trains of a hybrid vehicle usually comprise a combination of an internal combustion engine and an electric motor, and enable, for example in urban areas, a purely electric mode of operation while at the same time permitting both sufficient range and availability, in particular when driving cross-country. In addition, it is also possible to use the internal combustion engine and the electric motor at the same time for driving purposes in certain operating situations.

In the development of electric machines intended for e-axles or hybrid modules, there is a continuing need to increase their power densities, so the cooling of electric machines required for this is growing in importance. Owing to the necessary cooling capacities, hydraulic fluids such as cooling oils have become established in most concepts for the removal of heat from the thermally loaded regions of an electric machine.

Jacket cooling as well as winding head cooling are known, for example, from the prior art for cooling electric machines by means of hydraulic fluids. While jacket cooling transfers the heat generated at the outer surface of the stator laminated core into a cooling circuit, the heat transfer takes place in the case of the winding head cooling immediately at the conductors outside the stator laminated core in the region of the winding heads into the fluid.

Further improvements are provided by separate cooling channels, which are introduced both in the stator laminated core (see, for example, EP3157138 A1) and in the slot, in addition to the conductors (see, for example, Markus Schiefer: Indirekte Wicklungskühlung von hochausgenutzten permanenterregten Synchronmaschinen mit Zahnspulenwicklung [Indirect Winding Cooling of Highly Utilized Permanently Excited Synchronous Machines with Toothed Coil Winding], dissertation, Karlsruhe Institute of Technology (KIT), 2017).

Increasingly, electric machines without a housing are also being used, for example in order to save weight. In the case of such high output class electric machines without a housing, it is usually necessary to actively cool the laminated cores. For this purpose, cooling channel paths are usually necessary that require a series and/or parallel connection of the cooling channels in the laminated core. To realize this, components are placed at the inlets and/or outlets of the cooling channels that control the diversion of the cooling fluid into the corresponding cooling channels. In this regard, it is also possible that multiple components are required for these diverting purposes. What these components have in common is that additional contours must be provided for the diversion of the cooling fluid in each case. These contours are sometimes complex and therefore generally expensive to produce. Furthermore, such components for diverting the cooling fluid can lead to a high pressure loss in the cooling circuit, which is generally undesirable.

GB 389 313 A discloses an air-cooled electric machine with a cooling channel geometry provided in the stator. DE 10 2017 214 427 A1 describes a stator for an electric machine, having at least one stator laminated core, and having at least one end cap following the stator laminated core in the axial direction of the stator, wherein at least one conducting element is provided which is formed separately from the end cap and separately from the stator laminated core and has at least one first cooling channel through which a cooling medium can flow for cooling the stator, which has a first longitudinal region extending in the stator laminated core and a second longitudinal region which extends in the end cap, which has at least one second cooling channel through which the cooling medium can flow and which is fluidically connected to the first cooling channel.

### SUMMARY

The object of the disclosure is therefore to avoid or at least mitigate the disadvantages known from the prior art and to provide a stator which does not require any additional components in order to form a series and/or parallel connection of fluid channels in the laminated core. It is also the object of the disclosure to implement a stator with a series and/or parallel connection of fluid channels in the laminated core, the pressure loss of which is as low as possible and which at the same time ensures the best possible heat transfer.

This object is achieved by a stator for an electric machine, comprising a stator body which is formed from a plurality of stator laminations arranged in layers, and wherein the stator body has a plurality of fluid channels through which a cooling fluid can flow, as well as a A-bearing shield and an B-bearing shield, which are arranged in each case on the end face and on opposite end faces of the stator body, wherein the A-bearing shield and/or the B-bearing shield and/or the stator body has/have at least one hydraulic connection, by means of which the cooling fluid can be conducted through the A-bearing shield and/or the B-bearing shield and/or the stator body to at least one of the fluid channels, wherein the stator body has a first group of stator laminations having a plurality of fluid channels which extend through the stator body substantially in the axial direction and a second group of stator laminations having a plurality of connection channels which extend through the stator body substantially in the circumferential direction, by means of which two fluid channels that are adjacent to one another in the circumferential direction are fluidically coupled together.

This achieves the advantage that a diversion and pressure loss control of the fluid channels and the corresponding cooling system can be effected in a simple manner by means of appropriately designed stator lamination groups. Additional components for diverting the cooling fluid can therefore be omitted. This can serve to reduce the number of stator components and the cost of producing the stator. One of the core ideas of the disclosure is therefore to implement the cooling channel path completely or at least partially in the laminated core. The necessary diversions, which previously had to be implemented using separate components, are also implemented in the stator laminated core in this case.

In this regard, the two stator lamination groups have different lamination geometries, which are arranged in an axially layered manner in such a way that cooling channels including a possibility for diversion of the cooling fluid can be formed in the stator body. Different laminations are used in the stator lamination groups for this purpose. The laminations can be cut using a stamping tool with controlled stamps, for example, which makes it particularly cost-effective to produce the stator lamination groups. In this regard, the fluid channels and/or the connection channels are preferably formed as windows in the respective stator lamination group. The length or axial extent of the fluid and/or connection channels can be adjusted and adapted by lining up the stator lamination groups or the stator laminations from which they are formed.

Furthermore, the disclosure makes it possible to control the pressure loss via the number of stator laminations in the region where the cooling fluid is diverted. This allows the pressure loss along the cooling channel to be adjusted or reduced to a desired minimum. By changing the number of individual laminations in the outer groups, one of the outer groups of stator laminations, which realize the diversion of the cooling fluid in the stator body by means of the connection channels, the pressure loss along the fluid channels can be changed or adjusted. For example, the pressure losses associated with the diversions of the cooling fluid on the opposite end faces of the cylindrical ring-shaped stator body can be adjusted separately in this regard.

The individual elements of the claimed subject matter of the disclosure and preferred embodiments of the subject matter of the disclosure will be described in the present disclosure and drawings.

The stator according to the disclosure is intended for use in an electric machine. The electric machine is used to convert electrical energy into mechanical energy and/or vice versa, and generally comprises a stationary part referred to as a stator, stand, or armature, and a part referred to as a rotor or runner, and arranged movably, in particular rotatably, relative to the stationary part. In particular, the electric machine is dimensioned such that vehicle speeds of more than 50 km/h, preferably more than 80 km/h and in particular more than 100 km/h can be achieved. The electric motor particularly preferably has an output of more than 30 kW, preferably more than 50 KW and in particular more than 70 kW. Furthermore, it is preferred that the electric machine provides speeds greater than 5,000 rpm, particularly preferably greater than 10,000 rpm, very particularly preferably greater than 12,500 rpm.

For the purposes of this application, motor vehicles are land vehicles that are moved by machine power without being bound to railroad tracks. A motor vehicle can be selected, for example, from the group of passenger cars, trucks, small motorcycles, light motor vehicles, motorcycles, motor buses/coaches or tractors.

The stator according to the disclosure can preferably be configured for a radial flux machine. The stator of a radial flux machine usually has a cylindrical or cylindrical ring-shaped structure and generally consists of a stator body which is formed from electrical laminations that are electrically insulated from one another and are structured in layers and packaged to form laminated cores. With this structure, the eddy currents in the stator caused by the stator field are kept low. Distributed over the circumference, grooves or circumferentially closed recesses are embedded into the electrical lamination running parallel to the rotor shaft, and accommodate the stator winding or parts of the stator winding. Depending on the construction towards the surface, the grooves can be closed with closing elements, such as closing wedges or covers or the like, to prevent the stator winding from detaching.

The stator body is preferably designed in one piece. A one-piece stator body is characterized by the fact that the entire stator body is formed in one piece as viewed over the circumference. The stator body is usually formed from a plurality of stacked laminated electrical sheets (electrical laminations), wherein each of the electrical laminations is closed to form a circular ring. The individual laminations can be held together in the stator body, for example by adhesive bonding, welding or screwing.

According to an advantageous embodiment of the disclosure, the fluid channels can extend axially parallel to the axis of rotation of a rotor rotatably mounted relative to the stator, which has proven to be advantageous in terms of cooling capacity and pressure loss.

According to the disclosure, the first group of stator laminations is surrounded in the axial direction by two stator laminations of the first group of stator laminations. This allows the cooling fluid to be diverted at both end faces of the cylindrical ring-shaped stator body.

Furthermore, according to an equally advantageous embodiment of the disclosure, the axial extent of the first group of stator laminations can correspond to 3 to 10 times the axial extent of the second group of stator laminations, which has proven to be particularly advantageous in terms of the achievable cooling effect and pressure loss. According to the disclosure, the at least one closure plate of the stator body can further be arranged axially on a second group of stator laminations in such a way that at least one of the fluid channels and at least one connection channel is closed in the axial direction. In particular, the closure plate can be made of sheet metal or plastic. The closure plate is particularly preferably a stator lamination.

Furthermore, the disclosure can also be further developed in such a way that the closure plate has at least one supply channel, by means of which the hydraulic connection can be fluidically coupled to at least one of the fluid channels and/or connection channels, which is particularly favorable both with respect to the hydraulic implementation and the connections to be established.

In an equally preferred embodiment of the disclosure, a plurality of first groups of stator laminations can be arranged axially next to one another, whereby the length of the stator body can be adjusted.

It can also be advantageous to further develop the disclosure in such a way that the stator laminations of the first group of stator laminations and/or the stator laminations of the second group of stator laminations are formed substantially of the same parts, which is particularly advantageous in terms of production engineering.

According to the disclosure, the first group of stator laminations and the second group of stator laminations define a substantially meandering flow path for the cooling fluid, which has also proven to be particularly advantageous in terms of cooling capacity and pressure loss.

The function of the cooling fluid in the stator or in the electric machine is to dissipate heat as efficiently as possible from regions of the stator or electric machine that are heating up and to prevent these regions from overheating. In addition to this main task, the cooling fluid can in particular also provide lubrication and corrosion protection for the moving parts and/or the metal surfaces of the cooling system of the stator or the electric machine. In addition, it can, in particular, also remove contaminants (for example as caused by abrasion), water and air.

Finally, the disclosure can also be advantageously implemented in such a way that the cooling fluid is a liquid, in particular a cooling oil. In principle, however, it is also conceivable to use aqueous cooling fluids, for example also emulsions.

### BRIEF DESCRIPTION OF THE DRAWINGS

The disclosure is explained in more detail below with reference to drawings without limiting the general concept of the disclosure.

In the drawings:

FIG. 1 shows a stator with end shields in a perspective view,

FIG. 2 shows a stator with end shields in an exploded view,

FIG. 3 shows a stator with exposed fluid channels and end shields in an exploded view,

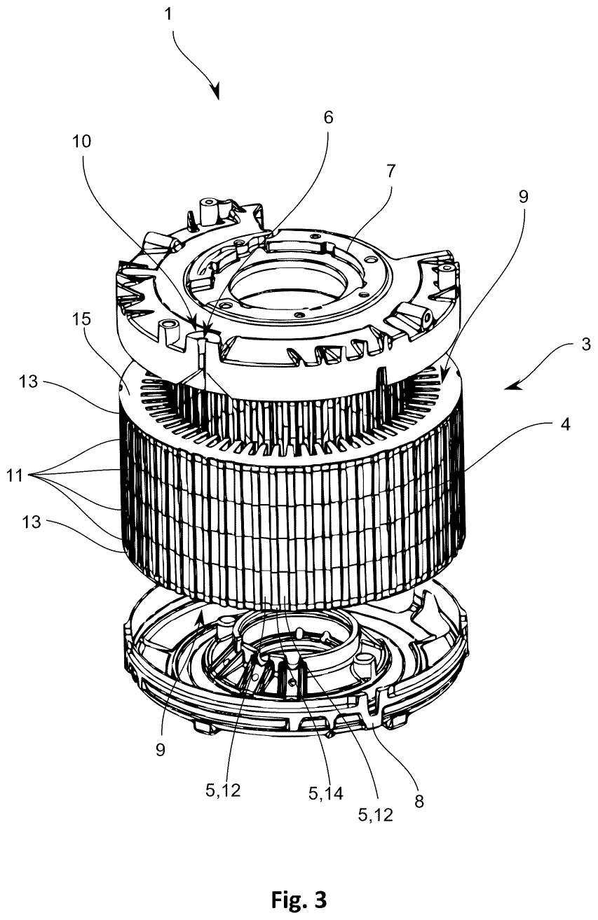

FIG. 4 shows a detailed view of a stator with exposed fluid channels in a perspective view,

FIG. 5 shows a detailed view of a stator with exposed, meandering fluid channels in a perspective view.

### DETAILED DESCRIPTION

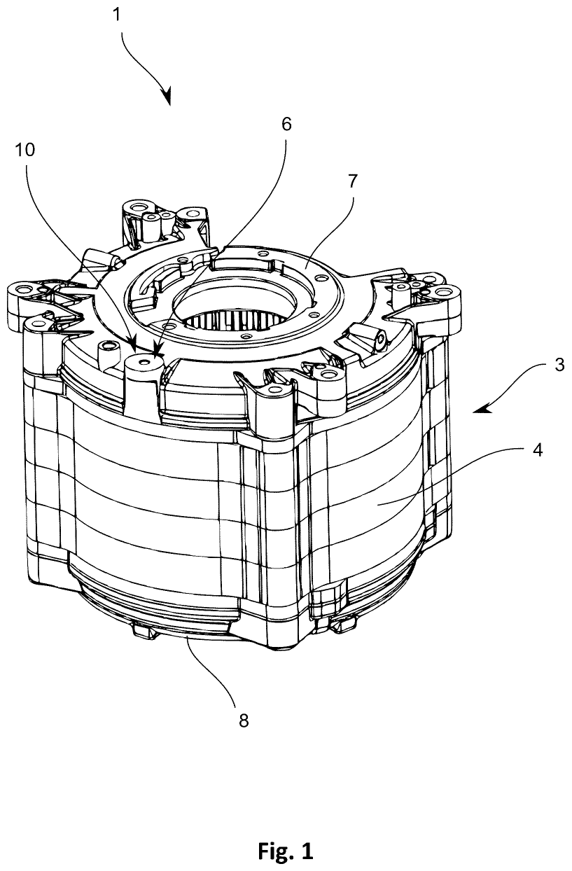

FIG. 1 shows a stator 1 for an electric machine, comprising a stator body 3 which is formed from a plurality of stator laminations 4 arranged in layers.

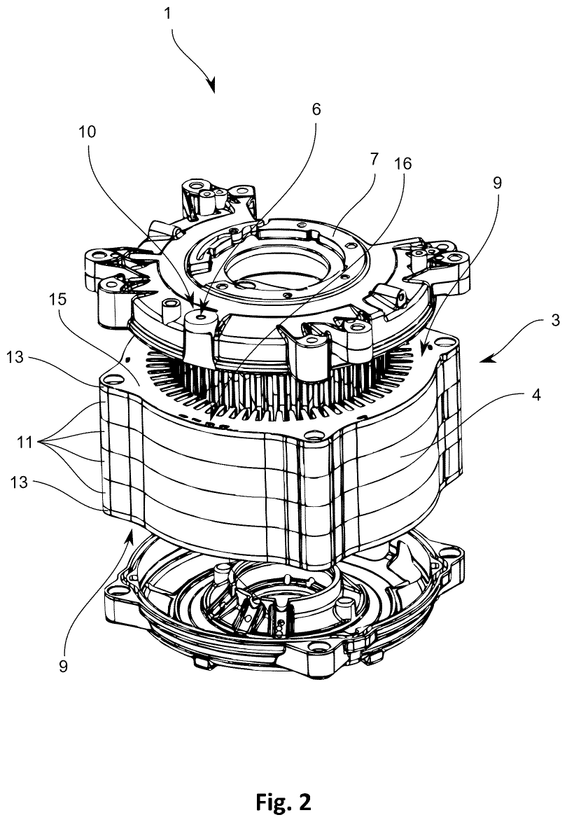

The stator body 3 has a plurality of fluid channels 5 through which a cooling fluid 6 can flow, as well as a A-bearing shield 7 and an B-bearing shield 8, which are arranged in each case on the end face and on opposite end faces 9 of the stator body 3. As can be seen from FIG. 2, the A-bearing shield 7 has a hydraulic connection 10, by means of which the cooling fluid 6 can be conducted through the A-bearing shield 7 to at least one of the fluid channels 5.

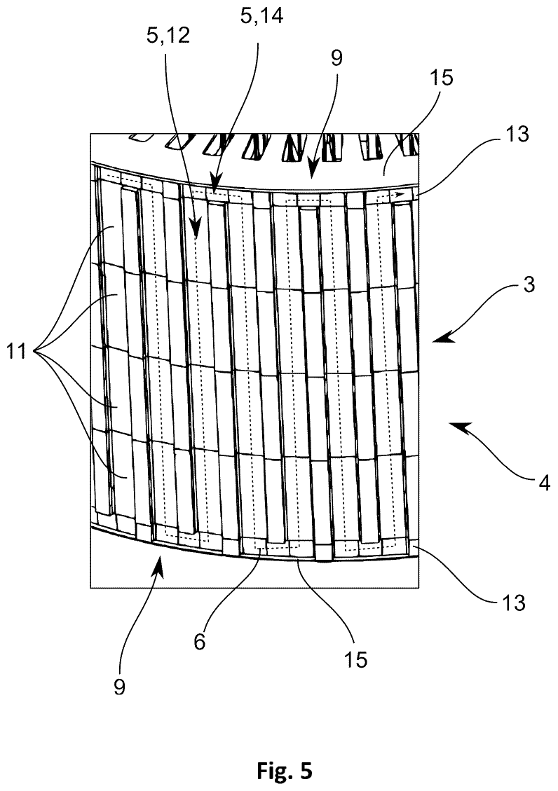

The stator body 3 is composed of a first group of stator laminations 11 having a plurality of fluid channels 12 which extend through the stator body 3 substantially in the axial direction and a second group of stator laminations 13 having a plurality of connection channels 14 which extend through the stator body 3 substantially in the circumferential direction, by means of which two fluid channels 12 that are adjacent to one another in the circumferential direction are fluidically coupled together. This can be seen particularly well in the detailed view of FIG. 5.

In this regard, the fluid channels 12, which have a circumferentially closed contour, extend axially parallel to the axis of rotation of a rotor rotatably mounted relative to the stator 1. In order to adjust the axial extent of the stator 1 or the axial extent of the fluid channels 12 over, as far as possible, the entire axial length of the stator 1, a plurality of first groups of stator laminations 11 are arranged axially next to one another. FIG. 5 also shows that the first group of stator laminations 11 and the second group of stator laminations 13 define a substantially meandering flow path for the cooling fluid 6. For this purpose, the first group of stator laminations 11 is surrounded in the axial direction by two stator laminations 13 of the first group of stator laminations 13. Furthermore, at least one closure plate 15 of the stator body 3 is arranged axially on a second group of stator laminations 13 in such a way that at least one of the fluid channels 12 and at least one connection channel 14 is closed in the axial direction.

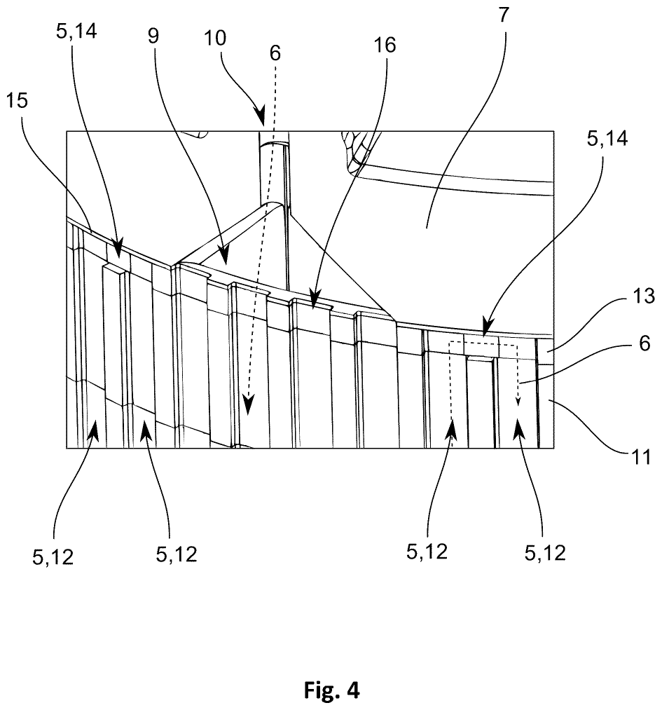

FIG. 4 shows that the closure plate 15 has at least one supply channel 16, by means of which the hydraulic connection 10 can be fluidically coupled to at least one of the fluid channels 12 and/or connection channels 14. For this purpose, the connection 10 can widen in a funnel-like manner in the direction of the supply channels 16 in order to allow an inflow of cooling fluid 6 to a plurality of fluid channels 12 or connection channels 14.

This results in a cooling circuit that conducts the cooling fluid 6 through the hydraulic connection 10 of the A-bearing shield 7 to the supply channel 16 of the closure plate 15, from which the cooling fluid 6 is then conducted in a meandering manner through the fluid channels 12 and connection channels 14 over almost the entire axial extent of the stator 1. The cooling fluid 6 can then be conducted back out of the stator 1 at a suitable point.

The disclosure is not limited to the embodiments shown in the drawings. The above description is therefore not to be regarded as limiting, but rather as illustrative. The following claims are to be understood as meaning that a stated feature is present in at least one embodiment of the disclosure. This does not exclude the presence of further features. Where the claims and the above description define ‘first’ and ‘second’ features, this designation serves to distinguish between 10 two features of the same type without defining an order of precedence.

### LIST OF REFERENCE SIGNS

1 Stator

3 Stator body

4 Stator laminations

5 Fluid channels

6 Cooling fluid

7 A-bearing shield

8 B-bearing shield

9 End faces

10 Hydraulic connection

11 Stator laminations

12 Fluid channels

13 Stator laminations

14 Connection channels

15 Closure plate

16 Supply channel

1. A stator for an electric machine, comprising:
a stator body formed from a plurality of stator laminations arranged in layers, wherein the stator body has a plurality of fluid channels through which a cooling fluid can flow,
an A-bearing shield and a B-bearing shield, which are arranged in each case on an end face and on opposite end faces of the stator body,
wherein at least one of the A-bearing shield, the B-bearing shield and the stator body has at least one hydraulic connection, by means of which the cooling fluid can be conducted through at least one of the A bearing shield, the B-bearing shield and the stator body to at least one of the fluid channels,
wherein the stator body has a first group of stator laminations having a plurality of fluid channels which extend through the stator body substantially in an axial direction and a second group of stator laminations having a plurality of connection channels which extend through the stator body substantially in a circumferential direction, by means of which two fluid channels that are adjacent to one another in the circumferential direction are fluidically coupled together,
wherein the first group of stator laminations is surrounded in the axial direction by two stator laminations of the second group of stator laminations,
wherein at least one closure plate of the stator body is arranged axially on the second group of stator laminations in such a way that at least one of the fluid channels and at least one connection channel is closed in the axial direction,
wherein the first group of stator laminations and the second group of stator laminations define a substantially meandering flow path for the cooling fluid.

2. The stator according to claim 1, wherein the fluid channels extend axially parallel to an axis of rotation of a rotor rotatably mounted relative to the stator.

3. The stator according to claim 1, wherein an axial extent of the first group of stator laminations corresponds to 3 to 10 times an axial extent of the second group of stator laminations.

4. The stator according to claim 1, wherein the closure plate has at least one supply channel, by means of which the hydraulic connection can be fluidically coupled to at least one of the fluid channels and/or connection channels.

5. The stator according to claim 1, wherein a plurality of first groups of stator laminations are arranged axially next to one another.

6. The stator according to claim 1, wherein the stator laminations of the first group of stator laminations and/or the stator laminations of the second group of stator laminations are formed substantially of the same parts.

7. The stator according to claim 1, wherein the cooling fluid is a liquid.

8. The stator according to claim 1, wherein the cooling fluid is a cooling oil.
